(19) United States
(12) Patent Application Publication
(10) Pub. No.: US 2013/0180157 A1
(43) Pub. Date: Jul. 18, 2013

(54) Spinning Reel Seat with Line Cutter

(71) Applicant: Matt Christopher Doucet, Rayne, LA (US)

(72) Inventor: Matt Christopher Doucet, Rayne, LA (US)

(21) Appl. No.: 13/352,888

(22) Filed: Jan. 18, 2012

(51) Int. Cl. A01K 97/00; A01K 87/06

(52) U.S. Cl. 43/22; 43/25

(57) ABSTRACT

An improved spinning reel seat with line cutter is provided, comprising a spinning reel seat having a base, wherein the base includes an upper grip and a mounting receptacle for attaching a line cutter; a line cutter having a mounting portion, wherein the mounting portion is adapted to matingly and detachably engage the mounting receptacle of the base; a slot formed into the line cutter, wherein the slot is adapted to accept a portion of fishing line; and a blade having a cutting edge, wherein the blade is positioned within the slot, and wherein the cutting edge is exposed to cut the fishing line when the fishing line is pressed against the cutting edge.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to devices for cutting fishing line, and more particularly to such devices which are attached to the fishing rod.

2. Description of Related Art

In the sport of fishing, it is frequently necessary to cut the fishing line. One example is when the fisherman needs to attach a lure to the line, wherein the previous lure is removed and a replacement lure is substituted in its place. Another example may be when there is a tangled or knotted line or other situation requiring a fresh length of line. Still another example is when excess line must be trimmed from the new lure.

These cutting operations can be troublesome, because they require a great deal of manual dexterity to use a pocket knife, fingernail trimmer, or even one's own teeth to cut the line, all the while holding the lure and tackle. Loose cutting devices like knives, trimmers, and other line cutters may be easily lost, and can be difficult to locate when they are needed. Such problems are only exacerbated by many other factors that may be present, such as sweaty hands, a crowded boat, wave action, and fishing at night.

Over the years, many devices have been developed for cutting fishing line. Some are portable, hand-held cutters, while others are attached to the fishing rod or reel themselves. Of those line cutters attached to the fishing rod, a number of patents are exemplary, namely U.S. Pat. No. 3,990,148 (Rienzo), U.S. Pat. No. 4,730,409 (Mitchell), U.S. Pat. No. 4,823,498 (Banta), U.S. Pat. No. 5,025,585 (Powell), U.S. Pat. No. 5,182,874 (Powell), and U.S. Pat. No. 7,389,607 (Zwierski). I have also developed a reel seat for bait casting reels wherein a line cutter is integrated into the trigger of the reel seat, as described and claimed in U.S. Ser. No. 13/162,136, filed on Jun. 16, 2011, the disclosure of which is incorporated by reference herein. Each of those devices has its unique advantages and drawbacks, but none of them include a line cutter integrated with the upper grip on the casting rod.

In the typical rod configuration for a spinning reel, a two-part reel seat is affixed to the rod, which securely grips the base of the fishing reel by tightening a threaded portion against the base. Because the spinning reel is present below the rod for casting, the base of the reel is typically engaged by the index finger, while the remaining fingers are wrapped around the grip portion of the rod, and the thumb is placed on the thumb rest located on top of the reel seat. This establishes a firm grasp of the rod, and it offers ambidextrous use by the fisherman.

In devising an improved line cutter, a number of design criteria should be met. First, the line cutter should be easily within reach of the fisherman. Second, the line cutter must be located in a position that permits quick placement of the line against the blade. Third, the line cutter must be safe to the fisherman by preventing accidental injury. For the reasons explained elsewhere herein, the upper region of the reel seat provides an ideal location for a line cutter while providing many advantages over prior patents.

### SUMMARY OF THE INVENTION

Therefore, an improved spinning reel seat with line cutter is provided, comprising a spinning reel seat having a base, wherein the base includes a thumb rest; a slot formed into the thumb rest, wherein the slot is adapted to accept a portion of fishing line; and a blade having a cutting edge, wherein the blade is positioned within the slot, and wherein the cutting edge is exposed to cut the fishing line when the fishing line is pressed against the cutting edge.

In a preferred embodiment, the blade is positioned transverse to the slot.

In another embodiment, the blade is molded into the thumb rest.

Preferably, the slot is located on an upper surface of the thumb rest.

Another embodiment of the invention is provided wherein the blade is recessed within the slot to such an extent as to minimize accidental injury to a user.

Also provided is an improved spinning reel seat with line cutter, comprising a spinning reel seat having a base, wherein the base includes an upper grip and a mounting receptacle for attaching a line cutter; a line cutter having a mounting portion, wherein the mounting portion is adapted to matingly and detachably engage the mounting receptacle of the base; a slot formed into the line cutter, wherein the slot is adapted to accept a portion of fishing line; and a blade having a cutting edge, wherein the blade is positioned within the slot, and wherein the cutting edge is exposed to cut the fishing line when the fishing line is pressed against the cutting edge.

In one embodiment, the mounting receptacle includes one or more guide rails, and wherein the mounting portion of the line cutter slides into a predetermined position on the base.

In another embodiment, the line cutter is removably attachable to the mounting receptacle by a fastener.

In a preferred embodiment, the blade is positioned transverse to the slot.

Optionally, the blade is molded into the line cutter.

In a more preferred embodiment, the slot is located on an upper surface of the line cutter, and the blade is recessed within the slot to such an extent as to minimize accidental injury to a user.

Preferably, the line cutter includes an upper surface adapted to serve as a thumb rest.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1A shows a side view of a typical rod and spinning reel seat modified in accordance with a preferred embodiment of the present invention.

FIG. 1B shows a detail view of the line cutter of FIG. 1A.

FIG. 2 shows a view of an alternate embodiment of the invention in which the line cutter is detachable from the reel seat.

FIGS. 3A-3C show front, top, and side views, respectively, of the line cutter of FIG. 2.

FIG. 4 shows an alternative embodiment in which the line cutter is inserted into the reel seat upper grip and attached with a fastener.

FIG. 5 shows the line cutter of FIG. 4 in an installed configuration.

FIGS. 6A-6C show front, top, and side views, respectively, of the line cutter of FIG. 4.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

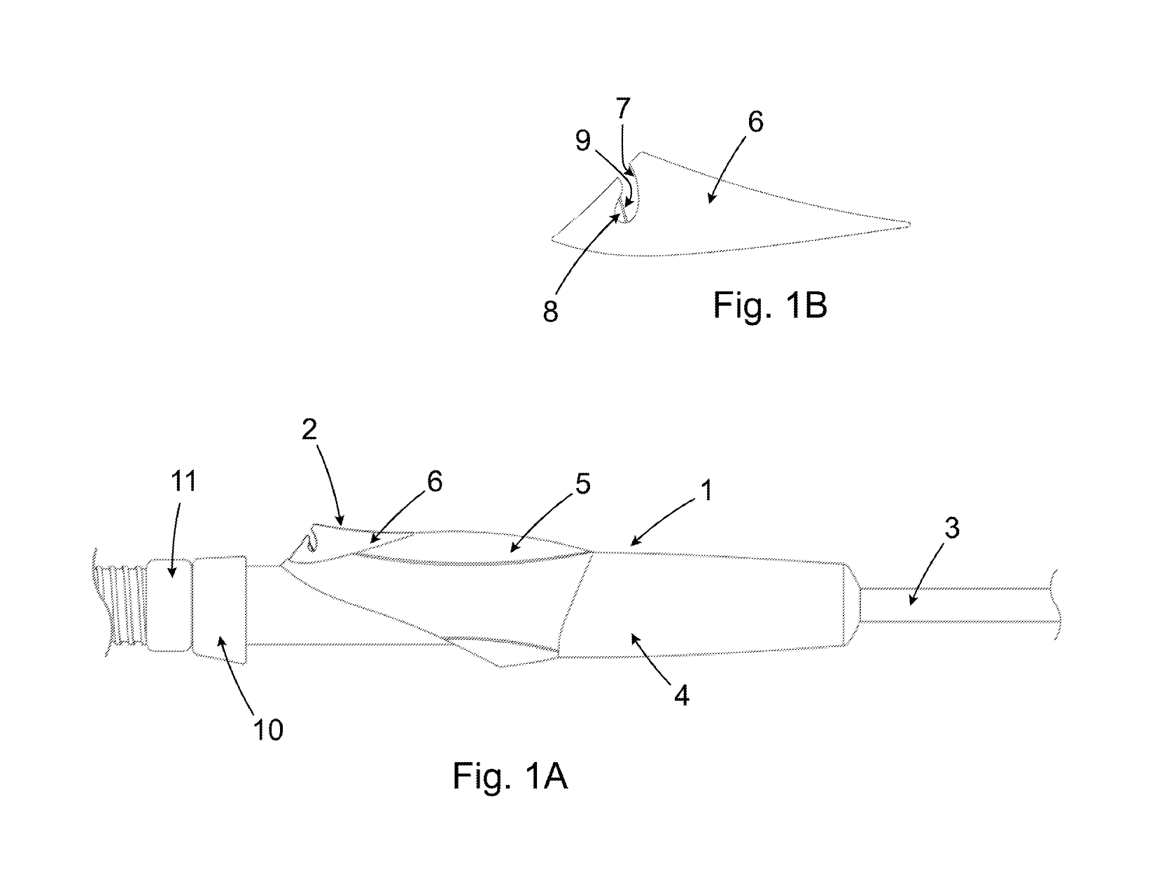

Turning now to FIGS. 1A and 1B, a preferred embodiment of the invention in the form of an improved spinning reel seat 1 with a permanently installed line cutter 2 is shown in conjunction with an otherwise conventional fishing rod 2. The spinning reel seat 1 includes a base 4, wherein the base 4 includes a grip 5 and a thumb rest 6. The reel seat 1 also includes a movable clamp 10 and a threaded nut 11 to retain a spinning reel. A slot 7 is formed into the thumb rest 6, wherein the slot is adapted to accept a portion of fishing line. A blade 8 (shown best in FIG. 1B) having a cutting edge 9 is positioned transverse within the slot 7, and the cutting edge 9 is exposed to cut the fishing line when the fishing line is pressed against the cutting edge 9. Preferably, the slot 7 is located on an upper surface of the thumb rest 6, although variations from this would also be suitable.

The reel seat 1 and thumb rest 6 as a single unit are preferably constructed of plastic materials typically used for rod components of this type. The blade 8 should be constructed from a metal or other material that is resistant to the effects of corrosion, and particularly from corrosion due to exposure to salt water environments.

In the preferred embodiment, the blade 8 is positioned within the line cutter 6 during the molding process, such that the cutting edge 9 is exposed within the slot 7. Preferably, the blade 8 is recessed within the slot 7 to such an extent as to minimize accidental injury to a user.

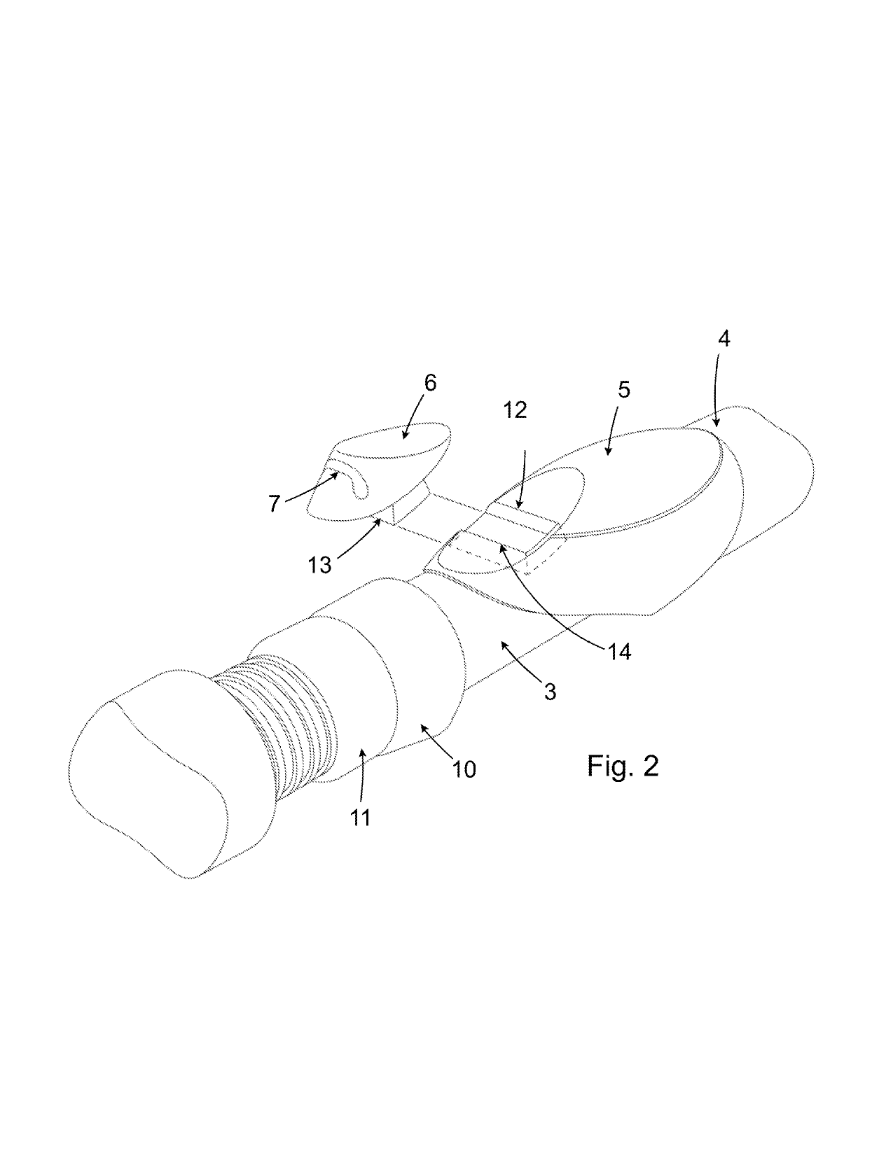

FIG. 2 depicts an alternative embodiment of the invention, but one in which the thumb rest and line cutter 6 is detachable from the grip 5. The base 4 includes an upper grip 5 and a mounting receptacle 12 for attaching the line cutter 6. The line cutter 6 includes a mounting portion 13, wherein the mounting portion 13 is adapted to matingly and detachably engage the mounting receptacle 12 of the base 4. Similar to the embodiment of FIGS. 1A and 1B, a slot 7 formed into the line cutter 6, wherein the slot 7 is adapted to accept a portion of fishing line. The blade 8 includes a cutting edge 9, wherein the blade 8 is positioned transverse within the slot 7, and wherein the cutting edge 9 is exposed to cut the fishing line when the fishing line is pressed against the cutting edge 9.

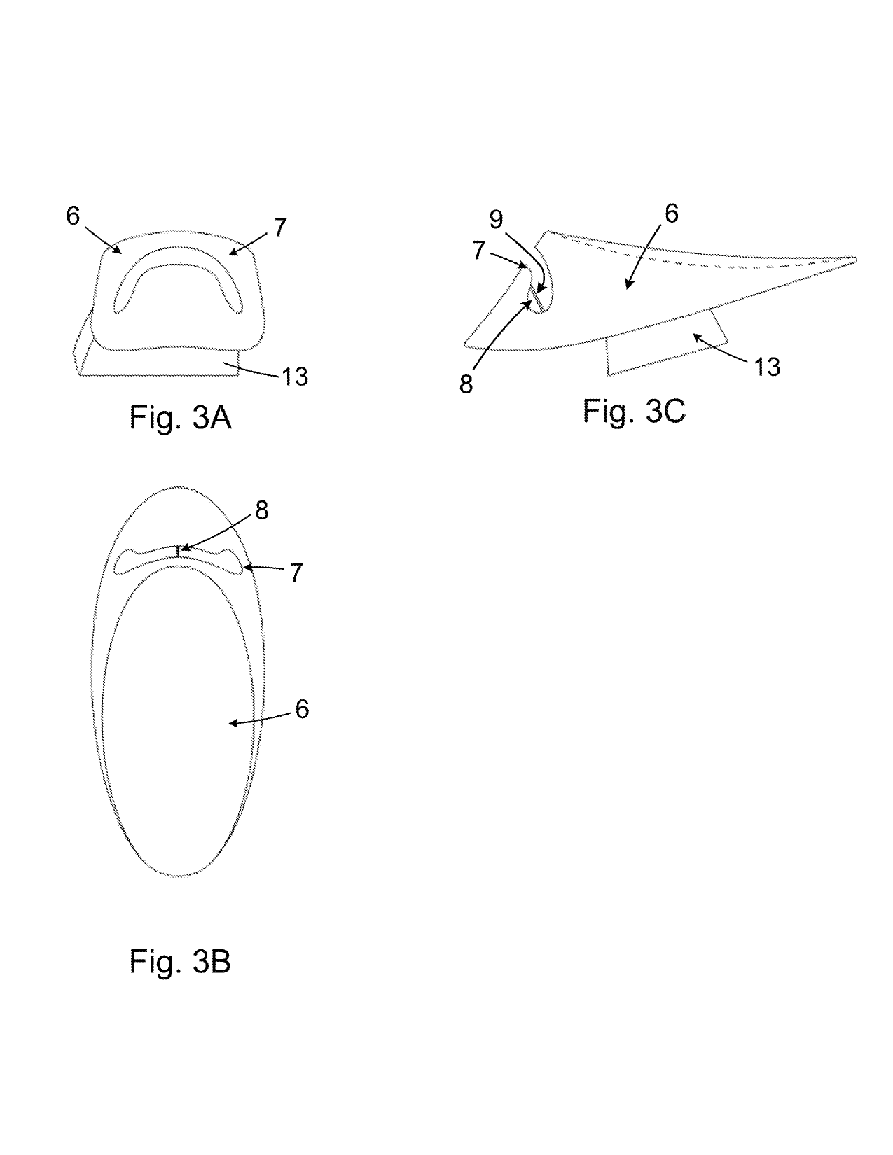

In the embodiment of FIG. 2, the mounting receptacle 12 includes one or more guide rails 14, and wherein the mounting portion 13 of the line cutter 6 slides into a predetermined position on the base 4. FIGS. 3A-3C are further detail views of the front, top, and side of the line cutter 6.

When the line cutter 6 is attached to the base 4, the mounting portion 13 of the line cutter 6 is caused to slidably engage or “dove tail” the mounting receptacle 12 of the base 4 until the line cutter 6 reaches a predetermined position. In most cases, it is desirable that the line cutter 6 be stopped in its travel sideward at the point where the side surfaces are flush with the surfaces of the base 4. Thus, the mounting receptacle 12 and mounting portion 13 include means for retaining the line cutter 6 in its final position for use. It will be appreciated that the aforementioned mounting method for the line cutter 6 is only one of many possible methods. For example, the line cutter 6 may be attached and removed by other common mating structures, including clips, snaps, locking pins, and similar devices, all with equal effectiveness and without departing from the basic design of having a mounting receptacle 12 on the reel seat base 4 and a mounting portion on the line cutter 6.

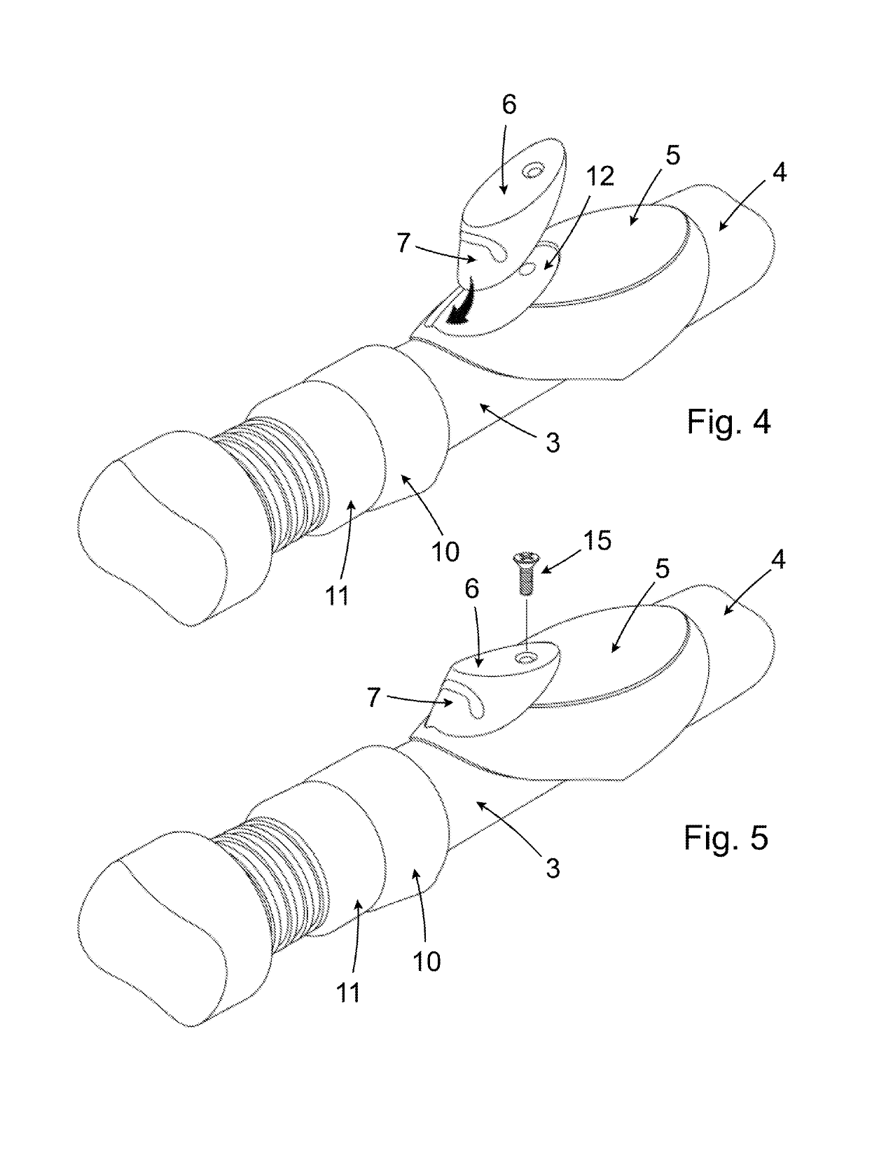

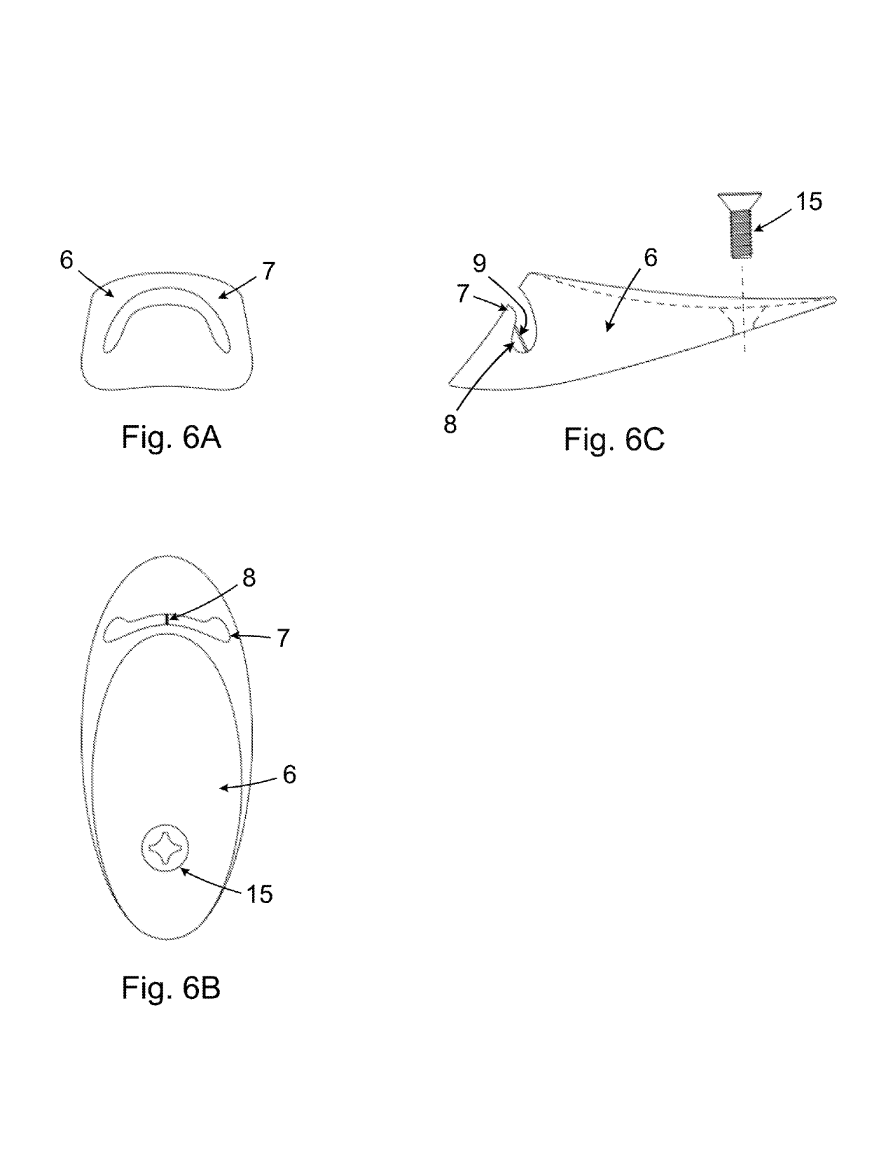

In another embodiment shown in FIG. 4, the line cutter 6 is removably attachable to the mounting receptacle 12 by a fastener 15, such as a screw or similar device which engages a mating portion on the mounting receptacle 12.

In the embodiments of both FIG. 2 and FIG. 4, the line cutter 6 includes an upper surface adapted to serve as a thumb rest during use.

It should be appreciated that variations of the present invention may be made on other portions of the reel seat 1. While the upper grip 5 provides the ideal location for a line cutter 6, similar blade positions are possible in a number of other places.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. An improved spinning reel seat with line cutter, comprising:
(a) a spinning reel seat having a base, wherein the base includes a thumb rest;
(b) a slot formed into the thumb rest, wherein the slot is adapted to accept a portion of fishing line; and
(c) a blade having a cutting edge, wherein the blade is positioned within the slot, and wherein the cutting edge is exposed to cut the fishing line when the fishing line is pressed against the cutting edge.

2. The reel seat of claim 1, wherein the blade is positioned transverse to the slot.

3. The reel seat of claim 1, wherein the blade is molded into the thumb rest.

4. The reel seat of claim 1, wherein the slot is located on an upper surface of the thumb rest.

5. The reel seat of claim 1, wherein the blade is recessed within the slot to such an extent as to minimize accidental injury to a user.

6. An improved spinning reel seat with line cutter, comprising:
(a) a spinning reel seat having a base, wherein the base includes an upper grip and a mounting receptacle for attaching a line cutter;
(b) a line cutter having a mounting portion, wherein the mounting portion is adapted to matingly and detachably engage the mounting receptacle of the base;
(c) a slot formed into the line cutter, wherein the slot is adapted to accept a portion of fishing line; and
(d) a blade having a cutting edge, wherein the blade is positioned within the slot, and wherein the cutting edge is exposed to cut the fishing line when the fishing line is pressed against the cutting edge.

7. The reel seat of claim 6, wherein the mounting receptacle includes one or more guide rails, and wherein the mounting portion of the line cutter slides into a predetermined position on the base.

8. The reel seat of claim 6, wherein the line cutter is removably attachable to the mounting receptacle by a fastener.

9. The reel seat of claim 6, wherein the blade is positioned transverse to the slot.

10. The reel seat of claim 6, wherein the blade is molded into the line cutter.

11. The reel seat of claim 6, wherein the slot is located on an upper surface of the line cutter.

12. The reel of claim 6, wherein the blade is recessed within the slot to such an extent as to minimize accidental injury to a user.

13. The reel seat of claim 6, wherein the line cutter includes an upper surface adapted to serve as a thumb rest.
